(19) United States
(12) Patent Application Publication
(10) Pub. No.: US 2010/0064377 A1
(43) Pub. Date: Mar. 11, 2010

(54) ACCESS RIGHTS FOR DIGITAL OBJECTS

(76) Inventors: Stephen Farrell, Dublin (IE); Bill dehOra, Dublin (IE); Sean Coughlan, Dublin (IE)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 12/401,973

(22) Filed: Mar. 11, 2009

(30) Foreign Application Priority Data
Mar. 20, 2008 (IE) S2008/0215

(51) Int. Cl. G06F 21/00

(52) U.S. Cl. 726/28

(57) ABSTRACT

A digital object for distribution from a provider to a content user and a method of distribution of such an object is disclosed. The digital object comprises content and a tag containing data that is derived algorithmically from the content and from a secret not known to the content user. The tag is constructed such that the content user can, upon receipt of a communication from a requestor purporting to have the authority of the provider, perform an exchange of information with the requestor, and by inspection of the exchanged information and of the tag, determine whether the requestor is in possession of the secret and choose to act upon or not act upon the communication accordingly. The tag may additionally include a value that defines an access category that specifies the extent to which the owner wishes the content to be distributed. A server from which an object has been delivered to a third party can send a message to the third party to request, amongst other things, that the access category be changed. The third party can use the tag in the object to verify the authority of the request.

### FIELD OF THE INVENTION

This invention relates to a scheme for specifying access rights for digital objects. In particular, it relates to digital objects in respect of which an owner can specify access rights in a greater detail than is possible with conventional systems and maintain a degree of control over the object even after it has been made available on a public server.

### BACKGROUND OF THE INVENTION

An increase in the use of social networking and similar web sites has resulted in a rapid increase in the amount of personal information that is made available to the public. Such information can take many forms. Much of it is included in images stored in files in JPEG format, but it is also contained in text files (for example, those encoding web pages in using HMTL), video, weblogs, amongst others. People may find that their circumstances or preferences change, such that it would be most advantageous if personal information that had previously been made freely available to the public were to be brought back under closer personal control.

Traditionally, access control systems typically specify access available to an object using a range of categories. An example is the well-known “user, group, world” scheme used in UNIX file permissions (in which “world” refers to any user of the system on which the file resides). This traditional scheme is not particularly well suited for controlling access in current Internet applications. Using such a scheme, once an object is exposed to the world at large (e.g. via a web site), its owner no longer retains any meaningful control over it. In particular, an owner cannot impose an access limitation that is stricter than one previously imposed. Nor does such a traditional scheme allow a user to specify, in detail, who should have access to their objects and how such access should be available.

### SUMMARY OF THE INVENTION

An aim of the invention is to provide a system that allows the user to specify their privacy/publicity requirements for their content, and also allows the user to re-take control of their content, and, where that content has “escaped” from tight-control, allows the user to demonstrate ownership of their objects.

From a first aspect, this invention provides a digital object for distribution from a provider to a content user, the digital object comprising content and a tag containing an identifier value that is derived algorithmically from the content and a secret not necessarily known to the content user, whereby the tag is constructed such that the content user can, upon receipt of a communication from a requestor purporting to have the authority of the provider, perform an exchange of information with the requestor, and by inspection of the exchanged information and of the tag, determine whether the requestor is in possession of the secret and choose to act upon or not act upon the communication accordingly.

Therefore, if a person or computer system that possesses an object embodying the invention receives a request concerning the object (for example, a “take-down” request to remove the object from public access) it is possible to determine whether or not the request appears to come from a legitimate requestor. If the exchange of data proves that the requestor is in possession of the secret, it is reasonable to assume that the secret was communicated to the requestor by the person or system that applied the tag to the object, and it is therefore reasonable to assume that the requestor has the authority to make the request.

Most advantageously, the tag is constructed such that the exchange of information with the requestor does not disclose the identity of the source. Moreover, the tag is very advantageously constructed such that inspection of the tag and of data exchanged with the requestor does not provide a means of identification of other objects tagged using the same secret. These measures ensure that the privacy of the requestor is maintained. It is also advantageous that inspection of one tag and of the data exchanged with the requestor does not enable a person possessing the object to determine the secret, otherwise, the person possessing the object might be able to create messages that purport to have the authority to make requests connected with other objects from the same source.

In preferred embodiments, the tag is calculated using a modification of the well known Diffie-Hellman process for key exchange. More specifically, the tag is calculated as a value H(g^{H′(Pass∥O)} mod p) where H( ) is a hash function, O is the object, Pass is a secret, H′( ) is a modified hash function producing outputs that are of similar size to p, and p and g define the multiplicative group of integers modulo p, where p is prime and g is a primitive root mod p.

A digital object embodying this aspect of the invention typically further includes a tag that contains an access category associated with the content. The purpose of the access category is to specify the degree to which the object should be distributed, and may be used in co-operation with the identifier value to establish whether the originator of a request to change the access category is authorised to make the request.

A digital object embodying the invention may be a graphical image file in which the content includes graphical image data and the tag is contained within a tag field of the graphical image file or a video file. A JPEG file can be conveniently tagged using an EXIF data field.

Alternatively, a digital object embodying the invention may be a text file in which the content is encoded in a mark-up language and the tag is contained within a statement of the mark-up language. This allows a tag to be incorporated into a web page by inserting it into a statement that will not be interpreted by a web browser, and will therefore not be apparent to a person viewing the page.

From a second aspect, the invention provides a method of distribution of digital content, comprising receiving digital content from a user, creating a digital object according to the first aspect of the invention from the content, and conveying the digital object to third parties.

In such a method, a message concerning the object (such as a take-down request) may be sent to a third party to which the object has been distributed, and data is exchanged with the third party to establish that the sender of the message is in possession of the secret (and is therefore authorised to send the message).

Most typically, a method embodying this aspect of the invention further includes receiving an indication of the intended scope of distribution of the content from the user, and deriving from that indication an access category for the object, and the digital object is forwarded to third parties to the extent permitted by the access category. Following that, a message requesting that the access category of the object be changed may be sent to a third party to which the object has been distributed and data is exchanged with the third party to establish that the sender of the message is in possession of the secret.

To assist in subsequent location of the objects, a list may be maintained of third parties to which the object has been conveyed. Alternatively or additionally, a search for objects containing the tag may be performed, and a message is sent to each location identified as holding an object found by the search.

Most typically, an object distributed by a method embodying this aspect of the invention will be embedded in a web page. An example would be an image in a page of a social networking web site. A transfer of the object to a third party may be initiated by the server. The object may be “pushed” to others if an access category assigned to the object indicates the intention of the owner that it be actively publicised.

A method according to this aspect of the invention may distribute the object to a third party that indexes the content of web pages, such as an Internet search engine. It may also distribute the object to a third party that is contractually bound to act upon the content of messages sent to it having established that the sender of the message is in possession of the secret. The existence of such a contractual obligation may be a requirement imposed by an access category of the object.

From a third aspect, the invention provides a server for distribution of digital objects by performing a method according to the second aspect of the invention.

Note that this scheme can coexist with (but does not rely upon) so-called digital rights management (DRM) schemes. The objects considered here may or may not be protected using some DRM mechanism. For the purposes of the invention, it does not matter whether tags are embedded into objects using watermarking or other steganographic mechanisms; stored alongside objects as meta-data; stored within objects, for example as exchangeable image file format (EXIF) fields in a JPEG image whose formatting allows for the inclusion of tags; or used as part of the name by which an object is referenced, such as a URI.

As with any scheme that involved cryptographic operations, the numerical parameters used in any actual embodiment of the invention are chosen to ensure that it is computationally unfeasible within a reasonable time to break the security of the system using a “brute force” attack. It should also be realised that the security of some embodiments are based upon the difficulty of performing certain mathematical operations such as solving the discrete logarithm problem. As such, these embodiments may serve to conceal information about the content owner and prevent unauthorised use of the content owner's identity to a degree that is for practical purposes secure, but which theoretically, given sufficient time, could be defeated. Limitations within the claims should be construed accordingly.

### BRIEF DESCRIPTION OF THE DRAWINGS

An embodiment of the invention will now be described in detail, by way of example, and with reference to the accompanying drawings, in which:

FIG. 1 is a diagram of interconnected computers implementing a system that operates in accordance with an embodiment of the invention;

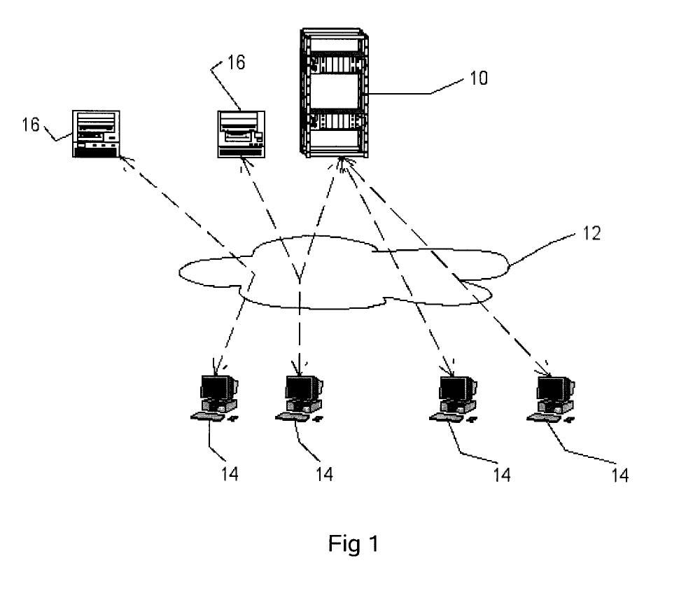

FIG. 2 is a diagram of a file into which a tag has been inserted in accordance with the invention; and

FIG. 3 is a dialogue box that might be used to allow a user to select an access category for one or more files in an embodiment of the invention.

### DETAILED DESCRIPTION OF CERTAIN PREFERRED EMBODIMENTS

The embodiment is constituted by a server system 10 that includes server software executing on a server computer connected to the Internet 12. The server system 10 may include a single computer, but in practice may include a cluster of computers over which load can be distributed. The computers of end users 14 can access the services provided by the server system 10 by accessing the server system over the Internet 12. Content held on the server system 10 can also be accessed by other servers 16 that provide end users 14 with other searches, such as image searching or other image processing services.

The services provided by the server system 10 allow a user to publish information including, amongst other things, images. For public Internet distribution, images are often encoded in the format known as JPEG, as defined in ISO 10918-1 and stored in image files. In addition to the data that defines the image itself, such files can also include metadata that relates to the image in the form of EXIF tags contained within the image file.

This embodiment provides a class of metadata that can be encoded within a JPEG file to indicate the owner's intentions as to how the image file should be accessed by or distributed to others: so-called “access categories”. This embodiment provides for twelve access categories, each of which represents the extent to which the owner wishes the image to be distributed to others. The access categories provided by this embodiment are set forth in Table 1, together with their definitions and intended use. The access categories are presented in Table 1 in order of decreasing privacy (or increasing publicity).

TABLE 1
Access Categories

| Access | | |
|---|---|---|
| Category | Description | Example use case |
| Only me | Protect the object so that only the | A file is encrypted and stored on a web |
| | owner can access it. Access to the | server with key management such that |
| | object store is not sufficient to | only the owner can decrypt the object. |
| | access the object. | |
| Me | Store the object so that only the | A file is stored on a web server such that |
| | owner can access it but such that | only the owner can access the object via |
| | access to the object store does | HTTP, for example using some form of |
| | allow access to the object. | user authentication. |
| Us | Store the object so that only the | Web server access permissions list a |
| | owner and explicitly nominated | number of users, not just the owner. |
| | entities can access the object. | |
| Them | Store the object so that only the | Web server access permissions list the |
| | owner and (possibly implicitly) | names of groups or roles; users must be a |
| | nominated entities can access the | member of one listed group or role to |
| | object. | access the object. |
| Logged | Store the object so that anyone can | Relevant and comprehensible web server |
| | access the object, but without | access log entries are made available to |
| | further efforts to make the object | the user; the file is readable by any |
| | more widely available and such | authenticated requestor; authentication |
| | that a log of accesses to the object | for this case can use a proxy-address or |
| | is made available to the owner. | might be more complex. |
| Unlinked | Store the object so that anyone can | The file is readable by any requestor, but |
| | access the object, but without | is protected from indexing, e.g. using a |
| | further effort to make the object | “robots.txt” file in the web server. |
| | more widely available. | |
| Index OK | Store the object so that anyone can | The file is readable by anyone, including |
| | access the object, and allow the | search engine robots. |
| | object to be indexed, but do not | |
| | index the object locally. | |
| Please Index | Store the object so that anyone can | The file is readable by anyone and |
| | access the object and insert links | visible in a site-map or other site-specific |
| | to or copies of the object into some | index. |
| | form of index. | |
| Pseudonymous | Store the object so that anyone can | Create a new identity (or re-use an |
| | access the object but so that the | identity) that is bound by the server to |
| | object is associated with a | the owner and publish the object under |
| | pseudonym that may be newly | that identity. |
| | created. | |
| Please Score | Store the object so that anyone can | The file is readable by anyone and is |
| | access the object and can also | presented in a frame that has a “rank |
| | “score” the object according to | this” button in a side-bar. |
| | some ranking scheme. | |
| Publicise | Store the object so that anyone can | The file is readable by anyone. Links to |
| | access the object and insert links | it are placed on a “front-page” of the |
| | to or copies of the object into | web site with a button to allow viewers |
| | highly-visible indexes. | to create new index entries (Such as a |
| | | “Digg This” link to create a link to the |
| | | object in the news aggregation website |
| | | www.digg.com. |
| Shout | Store the object so that anyone can | The file is readable by anyone and the |
| | access the object and insert copies | owner is willing to pay for an |
| | of or links to the object into highly | advertisement so that references to the |
| | visible indexes that may require | object are preferentially returned, for |
| | payment or publisher | example from a search engine. |
| | authentication. | |
| Flood | Store the object as in “Shout”. In | Make the object available in P2P |
| | addition, push the object out to | networks, for example, by adding it to a |
| | active distribution networks. | torrent server. |

It will be seen that these access categories provide for a much greater degree of granularity than is possible with conventional access control specifiers.

The specific categories set forth in Table 1 are not the only ones that could be defined, nor need they all be use in any given instance. Significantly, at least one of the access categories is such that the content can leave the control of the server.

In addition to the categories shown, the embodiment allows for additional rules to be defined and enforced possibly on a per-object and per-category basis. For example, an object categorised as “Us” might only be accessible during working-hours. In any given installation of this embodiment, an operator of the server can choose whether or not a content owner can define such rules. Similarly, the scope of the publicity associated with an object can be limited based on geography (for instance, such that the object is only made visible to users in some local area), or based on the topology of a network (for instance, such that an object is only made visible to users connected to a particular subnetwork or within a network cell).

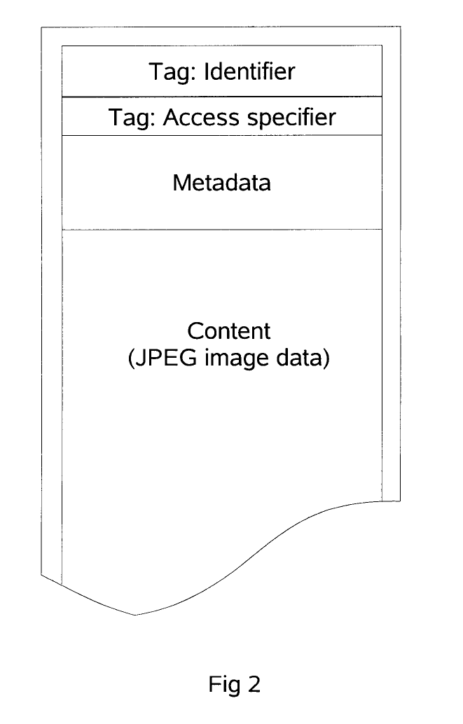

A specific scheme for implementing a tag for use in embodiments of the invention will now be described. As shown in FIG. 2, the tag is incorporated into a header of a file, such as a JPEG image file together with metadata normal to that type of file. The tag contains two values: an access category and an identifier. The access category is a simple numerical value that identifies one of the access category set forth in Table 1.

In addition to acting as an access category, a tag must allow an owner of an object to locate copies of it that have moved out of their direct control, and it must allow a person to prove ownership of the tagged object; this is the purpose of the identifier. However, the tag should not reveal the identity of the owner, nor should it enable a third-party to identify other objects that have been tagged by the same owner. This creates a need to be able to find the objects using a search engine, which in turn creates a need for a unique tag for each object. Since there may be situations where an owner wishes to request a “take-down” for an object, generating such tags so that the object “owner” can provide evidence that it is in fact the owner is also a requirement. Thus, the tagging scheme has the following requirements:
the owner can provide evidence of ownership;
a publisher can verify evidence of ownership;
a publisher cannot provide evidence of ownership to other publishers; and
a publisher cannot make use of evidence of ownership to correlate other objects owned by the same owner.

To meet these requirements there is provided a new tagging scheme based on Diffie-Hellman (D-H) key exchange scheme.

The conventional D-H scheme provides a cryptographic protocol that allows two parties that have no prior knowledge of one another to establish a shared secret key over an insecure communications channel. This key can then be used to encrypt subsequent communications using a symmetric key cipher. The original D-H implementation of the protocol specifies two parameters p and g to define the multiplicative group of integers modulo p, where p is a large prime number and g is a primitive root mod p.

In this embodiment, the tag is created as follows: given public parameters g and p (equivalent to the corresponding D-H parameters); a user-chosen or server-stored passphrase, Pass, and an object to be tagged, O, where the operator ∥ indicates concatenation;
calculate the tag x as H(g^{H′(Pass∥O)} mod p).
   where H′( )is a hash function that distributes uniformly over [0, p).

To verify ownership of the tag, the challenger (that is, for example, a third-party server that is questioning the authenticity of a request to change the status of an object) and the prover (the server on which the object was originally hosted) proceed as follows:
the challenger calculates g^{x} mod p and prover produces g^{H′(Pass∥O)} mod p, HMAC-SHA1(k, H(O)) where k=g^{x.H′(Pass∥O)} mod p and returns that value to the challenger.

The challenger can check the public D-H value and keyed-hash message authentication code (HMAC) calculation, given the object digest and x.

The result of this scheme is that tags are the length of the hash output (for example, the tag will be 256 bits if the SHA-256 hash function is used).

Pass can either be supplied by the server, or the client (for example, using client-side scripting), or a combination of both. The value of Pass must be effectively unguessable; an attacker with access to the object and tag could otherwise verify her guess at the Pass value, since there is no other unguessable input. However, it is safe to use the same Pass value with many different objects, so that the need to provide storage to store multiple Pass values for multiple objects required is avoided. If per-object secure storage is available, then such an object-specific value could be used as part of Pass. Pass could also take other stored information into account, for example, a timestamp associated with the creation of the object. (However, in many applications that will not be sufficiently hard to guess to make an attacker's job significantly harder.) In some applications, the server will already share some secret with the user, such as a login-passphrase or other authentication secret. This shared information could be used to strengthen the scheme by mixing in a hash of that value with other Pass inputs, without a requirement for additional storage.

If an attacker could guess the Pass value, they would be able to provide evidence of ownership (in the context of this invention, to request take-downs or change access category) for any associated object. Unguessable per-object storage of Pass avoids this potential weakness.

An alternative digital-signature-based scheme could be employed that would achieve the same effect, except that the verifier would be able to make use of the data exchanged to issue further take-down requests for the object in question and the verifier could also use the public key to correlate the sets of objects owned by the same entity. While that is a less attractive scheme, it could suffice in some use cases, where there is a sufficient level of trust between the server and the verifier.

The methods used to publish and access the objects here include standard web technologies including HTTP POST/GET requests and AJAX operations. In addition, there may be situations where the objects are published indirectly through some back-end infrastructure. As an example, this might include a case where a user posts an image from a mobile telephone equipped with a camera to a network operator server, which then posts the image to the user's social network account. This type of case is particularly important where access enforcement is applied by a mobile phone network operator, rather than by the social network server directly.

Note that some transitions between access categories are not strictly enforceable once the object has been put on a public web site. These transitions can only be done on a best-effort basis. For example, if an image has ever been in the “Indexed” category then copies of it may well have been taken thereby creating essentially new objects. Even though it is possible to apply more tight control to access the object subsequent to the change of access category, its copies are not so-controlled. However, the scheme does support the use of search and matching capabilities so that such copies may be found, reported on, and even potentially brought back under control.

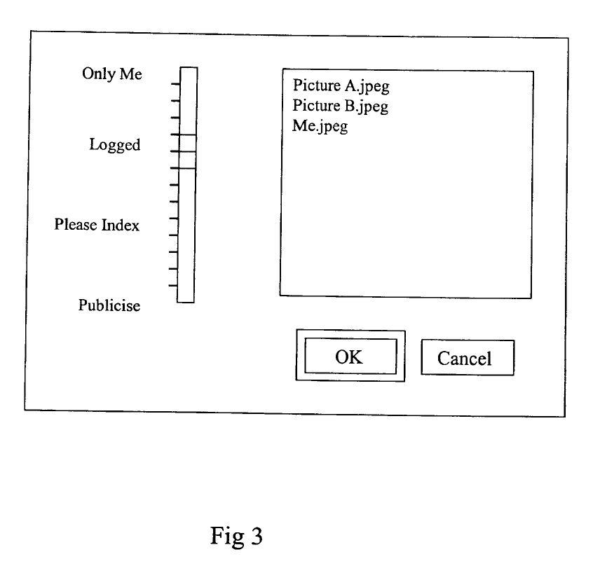

The extended access categories presented in Table 1 can be considered to be in a linear order of increasing permissiveness. This suggests a number of potential user interfaces that might be used to allow a user to select the access category for an object. For example, the primary user interface for the user to select an access category could include an object selector and a slider, as shown in FIG. 3. The object selector would implement a search interface that allows the user to select a set of objects to which an access category will be applied (possibly on a best-effort basis, as described above). The slider could present a set of access discrete categories. These might be a subset or superset of the categories in Table 1 as defined by a service operator and/or a service user). For each point on the slider there may be a drop-down list of category-specific options. For example, the category “Public” on the slider might have drop-down options for “Logged,” “Unlinked” and “IndexOK”). The user might also be presented with a dashboard of controls associated with each set of objects, so that the access category to be applied would be a point in a space whose size is determined by the cross-product of the set of individual dashboard controls.

As an example of the embodiment in use, suppose that a user “Alice” takes two photographs called “one” and “two”, that she then uploads to her social networking site, and marks both as being publicly visible and “indexed”. During the upload process each photograph is tagged by placing a tag in an EXIF data field of the JPEG image files with the access category “Please Index”, as defined in Table 1.

At some later time, perhaps years later, Alice wishes to make photograph “one” private, having the access category “OnlyMe”, as defiled in Table 1. By this time, copies of the photographs may be present in various web caches and on various web servers not under the control of Alice nor the operator of her social networking site.

In order to retake control of the photographs, Alice accesses her social networking server and sets the appropriate access category for the photograph in question. The server then carries out a web search for the photograph, based on the tag value, or using any other criteria, which results in a set of search hits. If Alice had initially chosen another category, “Shout”, for example, then her server may have records of where the photograph has been published. These may include organisations with which the operator of Alice's server has a business relationship, such as content publishers or other social networks.

For each search hit, Alice's server contacts the server hosting the copy of the photograph, and requests that it be deleted. This is substantiated by the ability of Alice's server to demonstrate ownership of the object by way of the tag. Third-party servers can safely honour this request so long as they are presented with evidence that the tag value in question is associated with Alice, as the owner of the object. However, Alice's identity is not exposed to the third-party server by this process. Moreover, the tagging scheme does not expose the fact that the second photo (“two”) also belongs to Alice, since that could represent a breach of Alice's privacy.

Following the set of exchanges, Alice's server can present Alice with the results, for example indicating which “hits” were successfully handled, and which were not (e.g. if some third parties do not respect the tagging scheme).

The same mechanism can be used to control access to other objects, including, but not limited to, web pages on web sites, files in a (perhaps distributed) file system, images in a photo-sharing application, blog-entries and other objects in a social networking application and other standard types of object typically represented via a MIME type or de-referenced through a URL. In addition to these objects, the scheme can also apply to more ephemeral objects, for example presence-related information or “friend” relationships as typically used in social networking applications.

DIGG is a registered trade mark of Digg, Inc.

UNIX is a registered trade mark of X/Open Company Limited.

What is claimed is:

1. A digital object for distribution from a provider to a content user, the digital object comprising content and a tag containing an identifier value that is derived algorithmically from the content and a secret not necessarily known to the content user, the tag being constructed such that the content user can, upon receipt of a communication from a requestor purporting to have the authority of the provider, perform an exchange of information with the requestor, and by inspection of the exchanged information and of the tag, determine whether the requestor is in possession of the secret and choose to act upon or not act upon the communication accordingly.

2. A digital object according to claim 1 in which the tag is constructed such that the exchange of information with the source does not disclose the identity of the requestor.

3. A digital object according to claim 1 in which the tag is constructed such that inspection of the tag and of data exchanged with the requestor does not provide a means of identification of other objects tagged using the same secret.

4. A digital object according to claim 1 in which the tag is constructed such that inspection of one tag and of the data exchanged with the requestor does not enable a person possessing the object to determine the secret used to construct the tag.

5. A digital object according to claim 1 in which the tag is calculated as a value H(g^{H′(Pass∥O)} mod p) where H( ) is a hash function, O is the object, Pass is a secret, H′( ) is a modified hash function producing outputs that are of similar size to p, and p and g define the multiplicative group of integers modulo p, where p is prime and g is a primitive root mod p.

6. A digital object according to claim 1 constituted by a graphical image file in which the content includes graphical image data and the tag is contained within a tag field of the graphical image file or a video file.

7. A digital object according to claim 6 in which the tag field is an EXIF data field.

8. A digital object according to claim 1 in which the object is a text file in which the content is encoded in a mark-up language and the tag is contained within a statement of the mark-up language.

9. A digital object according to claim 1 in which the digital object further includes a tag that contains an access category associated with the content.

10. A method of distribution of digital content, comprising receiving digital content from a user, creating a digital object according to claim 1 from the content, and forwarding the digital object to third parties.

11. A method of distribution of digital content according to claim 10 in which a message concerning the object is sent to a third party to which the object has been distributed together and data is exchanged with the third party to establish that the sender of the message is in possession of the secret.

12. A method of distribution of digital content according to claim 10 further comprising receiving an indication of the intended scope of distribution of the content from a user, and deriving from that indication an access category for the object, in which the digital object created is in accordance with claim 10, and the digital object is forwarded to third parties to the extent permitted by the access category.

13. A method of distribution of digital content according to claim 12 in which a message requesting that the access category of the object be changed is sent to a third party to which the object has been distributed and data is exchanged with the third party to establish that the sender of the message is in possession of the secret.

14. A method of distribution of digital content according to claim 11 in which a list is maintained of third parties to which the object has been conveyed and a message is sent to each party on the list.

15. A method of distribution of digital content according to claim 11, in which a search for objects containing the tag is performed, and a message is sent to each location identified as holding an object found by the search.

16. A method of distribution of digital content according to claim 10 in which the object is embedded in a web page.

17. A method of distribution of digital content according to claim 10 in which a transfer of the object to a third party is initiated by the server.

18. A method of distribution of digital content according to claim 10 in which the object is forwarded to a third party that indexes the content of web pages.

19. A method of distribution of digital content according to claim 10 in which the object is forwarded to a third party that is contractually bound to act upon the content of messages sent to it having established that the sender of the message is in possession of the secret.

20. A server for distribution of digital objects by performing a method according to claim 10.
